(19) United States
(12) Patent Application Publication
(10) Pub. No.: US 2001/0002897 A1
(43) Pub. Date: Jun. 7, 2001

(54) VIBRATION ABSORBER FOR OPTICAL DISK DRIVES

(76) Inventors: AN YING HUANG, TAINAN HSIEN (TW); TSUNG HUNG WU, TAINAN HSIEN (TW); SHENG FENG LIN, CHANGHUA HSIEN (TW)

Correspondence Address: Richard H. Tushin, Esq., DYKEMA GOSSETT PLLC, Franklin Square, Third Floor West, 1300 I Street, N. W., Washington, DC, 20005-3353, US

(21) Appl. No.: 09/263,768

(22) Filed: Mar. 5, 1999

(30) Foreign Application Priority Data
Sep. 7, 1998 (TW) 87111273

(51) Int. Cl. G11B 33/08

(52) U.S. Cl. 369/247; 369/75.1

(57) ABSTRACT

A vibration absorber includes at least one damping means attached to an optical disk drive for absorbing vibration of a base frame of the optical disk drive. The damping means includes at least one elastic member with proper stiffness and a damping coefficient and a rigid body providing mass and moment inertia effect.

### BACKGROUND OF THE INVENTION

1. Field of the Invention

The present invention relates to a vibration absorber for optical disk drive which reduces the vibration of the optical disk drive.

2. Description of the Related Art

A conventional optical disk drive generally includes a damper 7 and a rotor of a spindle motor 5 for clamping a disk 6 therebetween. The rotor of the spindle motor 5 has a better dynamic balance. Yet, the damper 7 and the disk 6 may not achieve dynamic balance as eccentric rotations may occur. When these members are rotated, a base frame of the optical disk drive vibrates. The faster these members rotate, the more violently the base frame vibrates. As a result, the pickup head cannot read information in the disk. The vibration problem also limits development of optical disk drives that operate disks by constant linear velocity. Matsushita Company proposes steel balls mounted in the disk damper to reduce dynamic unbalance. It is also suggested to place steel balls into the rotor of the spindle motor, and a spindle motor with automatic dynamic balance design has been adopted by many companies, e.g., NEC, TOHEI, etc. In order to reduce vibration of the base frame of the optical disk drive, some companies, e.g., TEAC, LITEON, propose to increase the weight of the base frame of the optical disk frame, while other companies, e.g., MITSUMI, A-OPEN, propose two layers of damping rubbers. The present invention is intended to provide an improved design to reduce vibrations of the optical disk drives.

### SUMMARY OF THE INVENTION

It is a primary object of the present invention to provide a vibration absorber for optical disk drives. The vibration absorber can be easily assembled and may effectively absorb vibration of the optical disk drives such that the pickup head may easily read information on the optical disk.

In order to achieve the above object, the present invention uses a damping means mounted to a base frame of an optical disk drive. The damping means has appropriate stiffness and an appropriate damping coefficient. When the base frame of the optical disk drive vibrates, the damping means may reduce vibration in a certain frequency range. As the damping means is simple in structure and thus can be easily assembled, and the optimal damping means with optimal damping coefficient can be selected from a simplified kinetic model according to result of analysis, the vibration absorber of the present invention may be easily assembled and may effectively absorb vibration.

In accordance with the present invention, a vibration absorber is provided for an optical disk drive having a base frame. The vibration absorber comprises one or a plurality of damping means attached to the optical disk drive for absorbing vibration of the base frame. Each damping means includes at least one elastic member with proper stiffness and damping coefficient and a rigid body providing mass and moment inertia effect.

The damping means may be attached to the base frame. Alternatively, the optical disk drive includes a disk loading device for carrying an optical disk, and the disk loading device and the base frame are arranged as one unit to which one or the plurality of damping means are attached. The damping means may be attached to either the disk loading device or the base frame.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view illustrating a clamping device for an optical disk according to prior art;

FIG. 2 is a top view of a base frame of an optical disk drive equipped with a vibration absorber in accordance with the present invention;

FIG. 3 is a right side view of the base frame in FIG. 2;

FIG. 4 is a schematic kinetic model of the vibration absorber in accordance with the present invention;

FIG. 5 is a diagram obtained by theoretical inference, illustrating relationship between frequency and amplitude of the base frame in accordance with the present invention, wherein the damping ratio ξ3 is 0.1;

FIG. 6 is a diagram obtained by theoretical inference, illustrating relationship between frequency and amplitude of the base frame in accordance with the present invention, wherein the damping ratio ξ3 is 0.01;

FIG. 7 is a diagram obtained by experiments, illustrating relationship between frequency and amplitude of the base frame in accordance with the present invention;

FIG. 8 is a top view of the combination unit of the base frame and the loading device equipped with a vibration absorber in accordance with the present invention;

FIG. 9 is a left side view of FIG. 8;

FIG. 10 is a top view of the combination unit of the base frame and the loading device equipped with a vibration absorber which is the upper case of the optical disk drive in accordance with the present invention; and

FIG. 11 is a left side view of FIG. 10.

### DETAILED DESCRIPTION OF THE PREFERRED EMBODIMENT

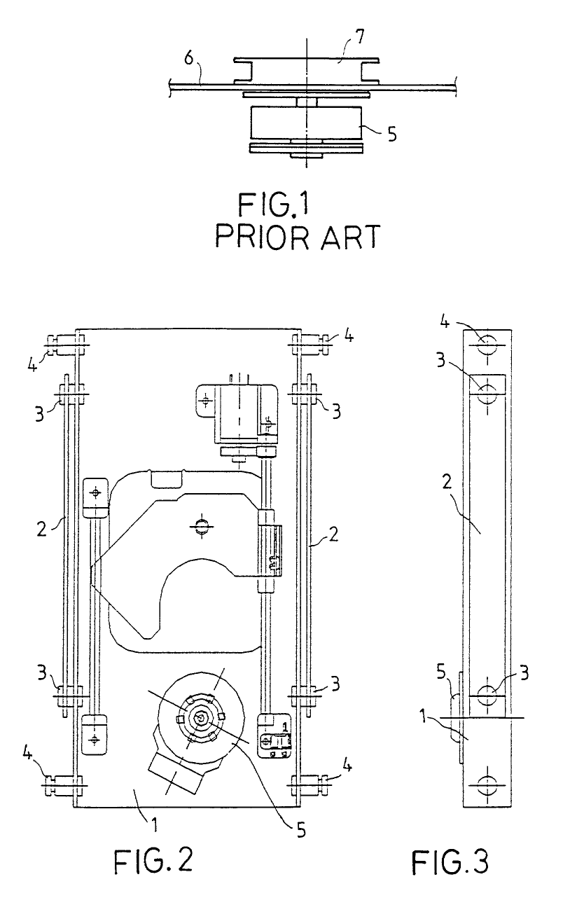

Referring to FIGS. 2 to 7 of the drawings and initially to FIGS. 2 and 3, an optical disk drive generally includes a plurality of dampers 4 mounted to a base frame 1 thereof. The present invention provides a vibration absorber including one or a plurality of damping means to improve the vibration-absorbing effect. Each damping means includes at least one elastic member 3 (e.g., a spring or damping rubber) attached to the base frame 1 and a rigid body 2 that may provide mass and moment inertia effect. In this embodiment, the elastic member 3 has appropriate stiffness and a damping coefficient. The damping means may be directly attached to the base frame 1, as shown in FIG. 2. Alternatively, The base frame 1 and the disk loading device 8 of the optical disk drive may be arranged as one unit such that the damping means may be attached either the base frame 1 or the disk loading device 8.

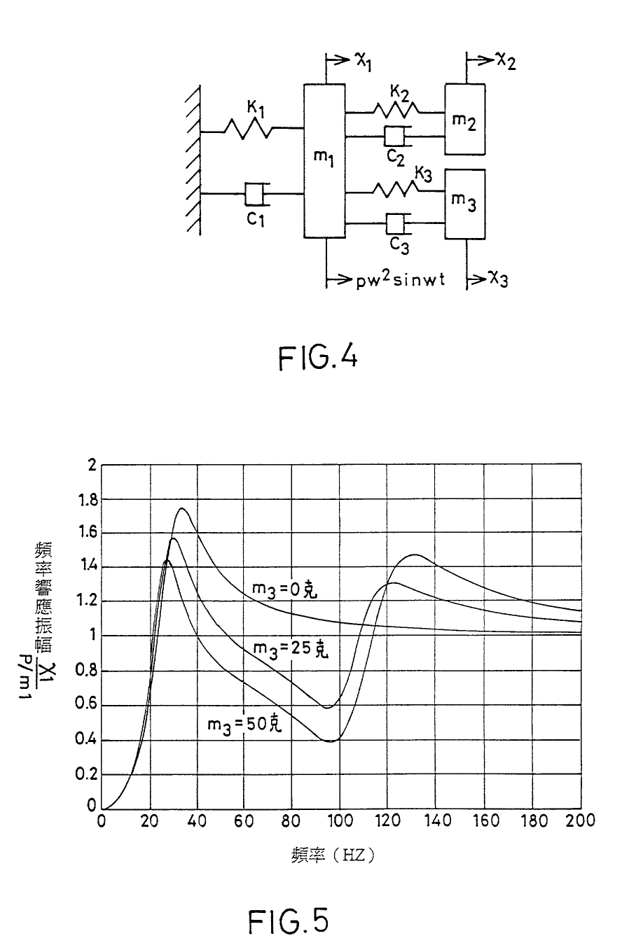

FIG. 4 illustrates a schematic kinetic model of the vibration absorber in accordance with the present invention. A matrix equation (1) of displacement/angular frequency ω can be obtained by means of analysis according to Newtonian mechanics:

$$[ \begin{matrix}m1 & 0 & 0 \\ 0 & m2 & 0 \\ 0 & 0 & m3\end{matrix} ] \cdot [ \begin{matrix}¨ \\ x1 \\ ¨ \\ x2 \\ ¨ \\ x3\end{matrix} ] + [ \begin{matrix}c1 + c2 + c3 & - c2 & - c3 \\ - c2 & c2 & 0 \\ - c3 & 0 & c3\end{matrix} ] \cdot [ \begin{matrix}\cdot \\ x1 \\ \cdot \\ x2 \\ \cdot \\ x3\end{matrix} ] + [ \begin{matrix}k1 + k2 + k3 & - k2 & - k3 \\ - k2 & k2 & 0 \\ - k3 & 0 & k3\end{matrix} ] \cdot [ \begin{matrix}x1 \\ x2 \\ x3\end{matrix} ] = [ \begin{matrix}p {ω}^{2} sin ω t \\ 0 \\ 0\end{matrix} ] \qquad ( 1 )$$

wherein m1, m2, m3 are masses of the base frame 1, the optical disk 6, and the damper 2, respectively; x1, x2, x3 are displacements (assuming that the displacement in the right direction is positive) of the base frame 1, the optical disk 6, and the damper 2, respectively; k1, k2, k3 are elastic constants of the base frame 1, the optical disk 6, and the damper 2, respectively; and c1, c2, c3 are damping coefficients of the base frame 1, the optical disk 6, and the damper 2, respectively.

$$Assume [ \begin{matrix}x1 \\ x2 \\ x3\end{matrix} ] = [ \begin{matrix}A sin ωt \\ B sin ω t \\ C sin ω t\end{matrix} ] \qquad ( 2 )$$

wherein A, B, C are amplitudes of the base frame 1 responsive to angular frequency ω.

The above matrix equation (1) can be simplified as follows:

$$[ \begin{matrix}\begin{matrix}( k1 + k2 + k3 + \\ j ( c1 + c2 + c3 ) ω - m1 {ω}^{2} )\end{matrix} & - {k}_{2} - j c2ω & - k - j c3 ω \\ - k2 - c2 ωj & k2 + j c2ω - {m2ω}^{2} & 0 \\ - k3 - j c3ω & 0 & k3 + j c3ω - m3 {ω}^{2}\end{matrix} ] \cdot [ \begin{matrix}A \\ B \\ C\end{matrix} ] = [ \begin{matrix}p {ω}^{2} \\ 0 \\ 0\end{matrix} ] \qquad ( 3 )$$

wherein p is a constant and j is an imaginary number.

By means of inverse matrix operation on equation (3), the following equation (4) can be obtained:

$$[ \begin{matrix}A \\ B \\ C\end{matrix} ] = [ \begin{matrix}H11 & H12 & H13 \\ H21 & H22 & H23 \\ H31 & H32 & H33\end{matrix} ] \cdot [ \begin{matrix}p {ω}^{2} \\ 0 \\ 0\end{matrix} ] \qquad ( 4 )$$

A solution can be obtained as follows:

x1=A sin ωt=H11pω² sin ωt (5)

x2=B sin ωt=H21pω² sin ωt (6)

Equation (7) can be obtained by means of subtracting equation (6) by equation (5).

x1−x2=(H11−H21)pω² sin ωt (7)

wherein:

H11=(k2+jc2ω−m2ω²)(k3+jc3ω−m3ω²)/[(k1+k2+k3+jω(c1+c2+c3)−m1ω²)(k2+jc2ω−m2ω²)(k3+jc3ω−m3ω²)−(k3+jc3ω)²(k2+jc2ω−m2ω²)−(k2+jc2ω)²(k3+jc3ω−m3ω²)],

H21=(k2+jc2ω)(k3+jc3ω−m3ω²)/[(k1+k2+k3+jω(c1+c2+c3)−m1ω²)(k2+jc2ω−m2ω²)(k3+jc3ω−m3ω²)−(k3+j c3ω)²(k2+jc2ω−m2ω²)−(k2+jc2ω)² (k3+jc3ω)−m3ω²)]

According to the result from the above theoretical inference, appropriate parameters (m3, k3, c3) of the vibration absorber and specific range of frequency can be selected to obtain a better consequence. In the case that the disk 6 and the base frame 1 of the optical disk drive have no obvious relative motion therebetween, the following parameters can be selected:

m1=132.5 g; fn1=30 Hz; ξ1=0.3,

wherein:

fn1 is the natural frequency of the base frame of the optical disk drive;

$$fn 1 = \frac{ω nI}{2 π} = \frac{I}{2 π} \sqrt{\frac{k1}{m1}} ;$$

$$fn 3 = \frac{ω n3}{2 π} = \frac{1}{2 π} \sqrt{\frac{k3}{m3}}$$

$$ξ 1 is the damping ratio , ξ 1 = \frac{c1}{2 m1 ω n1} , ξ 3 = \frac{c3}{2 m3 ω n3}$$

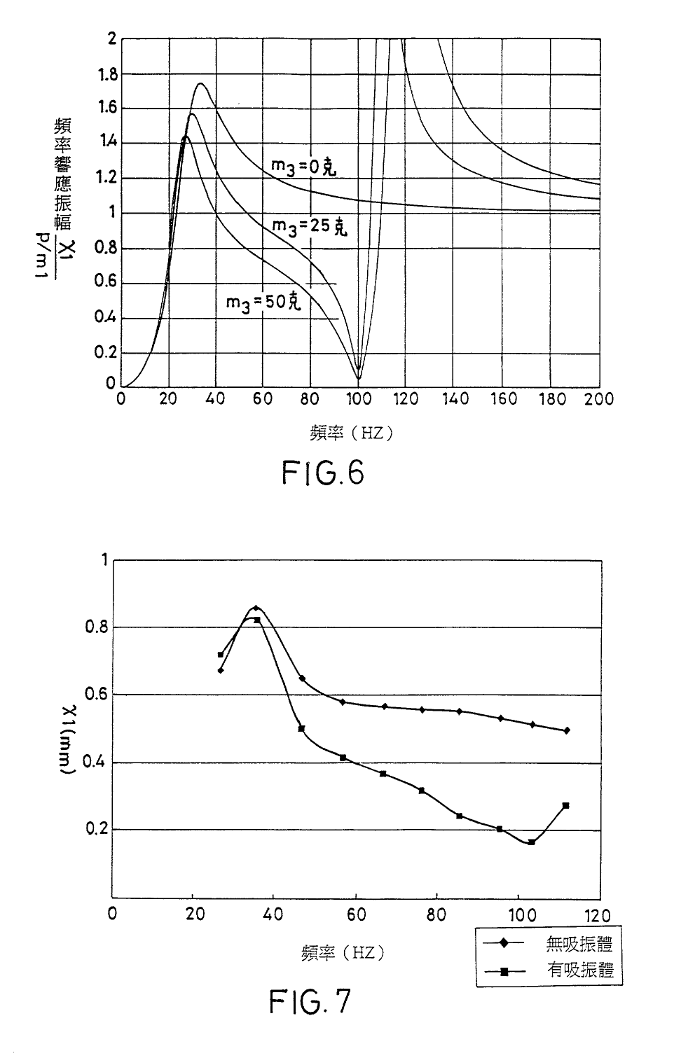

If fn3 is selected to be 100 Hz to depress vibration under a frequency of about 100 Hz, and different sets of m3 and ξ3 are selected, the relationship between the amplitude and frequency (in the range of 0˜200 Hz) are depicted in FIGS. 5 and 6, wherein the amplitude in FIGS. 5 and 6 are represented by a displacement unit

$$\frac{x1}{( p / m1 )}$$

that has no unit.

As can be seen from FIGS. 5 and 6, the damping effect becomes more obvious if the mass of the damper m3 is greater. In addition, the smaller the damping ratio is, the more obvious the anti-resonance point becomes. In this case, external force is almost absorbed by the damping means.

According to the above theoretical inference, damper with appropriate parameters can be selected. Under rotation of the rotor of the spindle motor 5 and the disk 6, displacement x1 of the base frame 1 is measured to verify the effect of the vibration absorber, and a result of the experiments is depicted in FIG. 7 and Table 1 listed below, in which the damp means is selected to include a copper plate of 25 g and a damping rubber with a damping ratio of 0.1. As a result, the vibration-absorbing effect provided by the vibration absorber of the present invention is significant under a frequency of 30˜100 Hz when compared to a base frame without vibration absorber of the present invention. The experimental result meets the result of theoretical inference. Accordingly, it is proved that the vibration absorber of the present invention may reliably absorb vibrations of the base frame during operation of the optical disk drive.

TABLE 1

| Frequency | Vibration(mm) | Vibration(mm) |
|---|---|---|
| (Hz) | (without damper) | (with damper) |
| 26.6 | 0.67 | 0.72 |
| 35.5 | 0.86 | 0.82 |
| 46.6 | 0.65 | 0.50 |
| 56.56 | 0.58 | 0.41 |
| 66.72 | 0.56 | 0.36 |
| 76.09 | 0.56 | 0.32 |
| 85.47 | 0.55 | 0.24 |
| 95.2 | 0.53 | 0.20 |
| 103.05 | 0.51 | 0.17 |
| 111.45 | 0.50 | 0.28 |

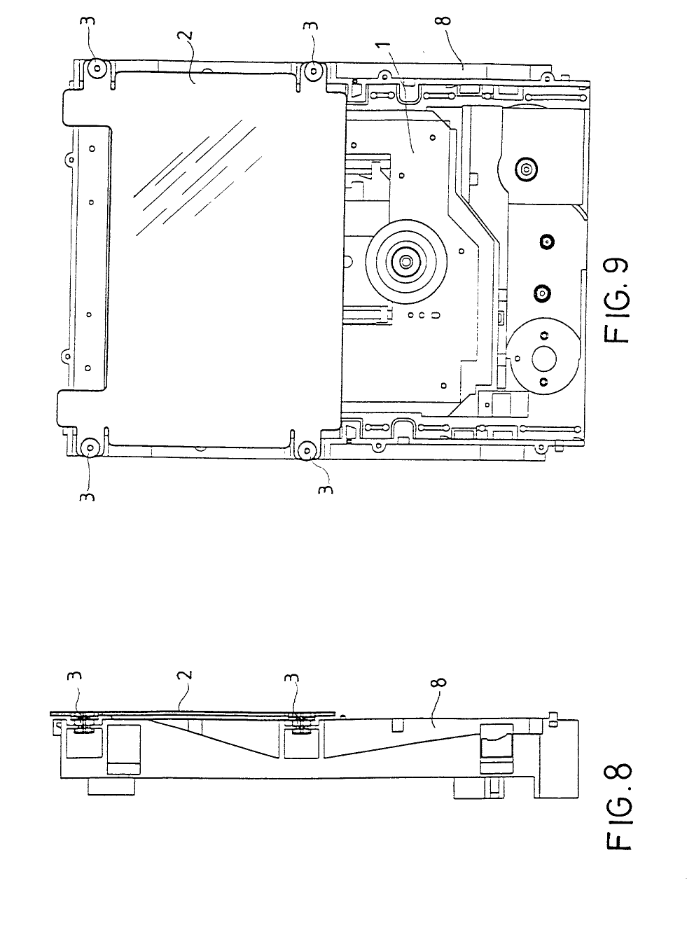

FIGS. 8 and 9 illustrate the second preferred embodiment in accordance with the present invention. The rigid body 2 having mass and moment inertia effect of the optical drive is disposed on the front surface of the loading device 8 which is mounted on the base frame 1 of the optical drive. The elastic member 3 is disposed between the loading device 8 and the rigid body 2 having mass and moment inertia effect (as shown in FIG. 9). According to the above analysis, the elastic member 3 and the rigid body 2 having mass and moment inertia effect can enhance the vibration absorbing effect.

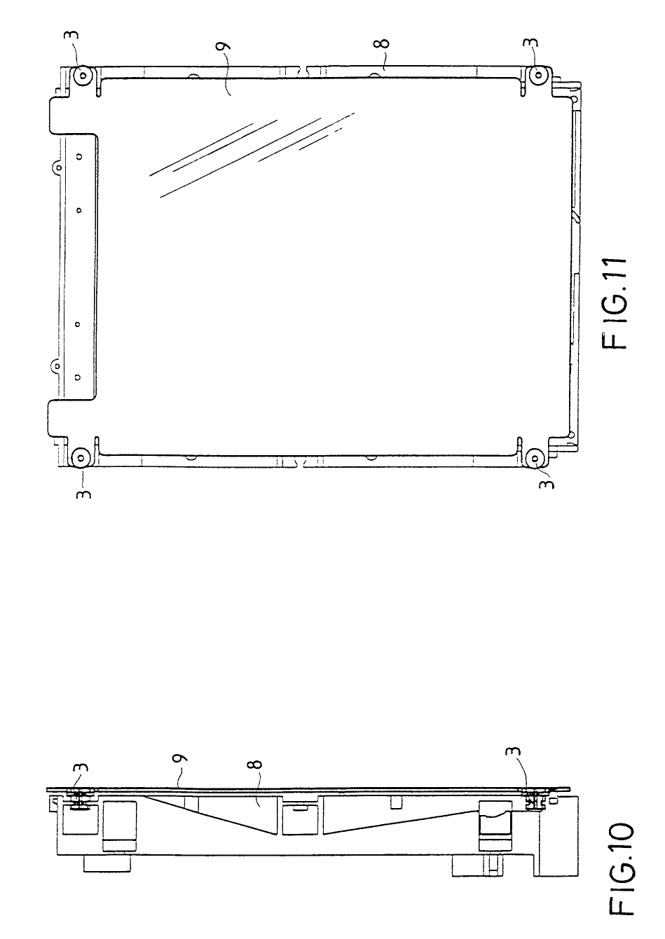

FIGS. 10 and 11 illustrate the third preferred embodiment in accordance with the present invention. The case 9 of the optical drive is the rigid body 2 having mass and moment inertia effect and is disposed on the front surface of the loading device 8 which is mounted on the base frame 1 of the optical drive. The elastic member 3 is disposed between the loading device 8 and the case 9 (as shown in FIG. 11). According to the above analysis, the elastic member 3 and the case 9 can enhance the vibration absorbing effect.

Although the invention has been explained in relation to its preferred embodiment, it is to be understood that many other possible modifications and variations can be made without departing from the spirit and scope of the invention as hereinafter claimed.

What is claimed is:

1. A vibration absorber for an optical disk drive having a base frame, the vibration absorber comprising at least one damping means attached to the optical disk drive for absorbing vibration of the base frame, each said damping means including at least one elastic member with proper stiffness and a damping coefficient and a rigid body providing mass and moment inertia effect.

2. The vibration absorber as claimed in claim 1, wherein said damping means is attached to the base frame.

3. The vibration absorber as claimed in claim 1, wherein said optical disk drive includes a disk loading device for carrying an optical disk, the disk loading device and the base frame are arranged as one unit to which said damping means are attached.

4. The vibration absorber as claimed in claim 3, wherein said damping means are attached to the disk loading device.

5. The vibration absorber as claimed in claim 3, wherein said damping means are attached to the base frame.
